(19) United States
(12) Patent Application Publication
(10) Pub. No.: US 2023/0229940 A1
(43) Pub. Date: Jul. 20, 2023

(54) AI ETHICS DATA STORES AND SCORING MECHANISMS

(71) Applicant: Dell Products L.P., Round Rock, TX (US)

(72) Inventors: Nicole Reineke, Northborough, MA (US); Stephen J. Todd, North Andover, MA (US)

(21) Appl. No.: 17/648,066

(22) Filed: Jan. 14, 2022

(51) Int. Cl. G06N 5/02

(52) U.S. Cl. CPC G06N 5/025

(57) ABSTRACT

One example method includes for each pillar in a group of AI ethics pillars, storing, in a datastore, context data concerning the AI ethics pillar, and the context data is determined using context rules. The method further includes storing, in the datastore, the context rules as minimum context requirements, and receiving, by the datastore, a request from a user to register an asset in the datastore. When user-supplied context information for the asset meets ethical requirements specified by the context rules, registering the asset in the datastore, and ensuring that an assessment mechanism is able to access, and assess, the context data for each AI ethics pillar.

### FIELD OF THE INVENTION

Embodiments of the present invention generally relate to processes for the generation and use of various analytical models. More particularly, at least some embodiments of the invention relate to systems, hardware, software, computer-readable media, and methods for creation and use of AI (artificial intelligence) ethics data stores that enable the ability to score the ethical efforts made by developers and other personnel during the development of analytical models.

### BACKGROUND

In their sometimes urgent quest to solve business problems, many companies incentivize their data scientists/engineers to reduce the window of time in between the framing of a business problem and the production of an analytic insight that solves the problem. As a result, data scientists and engineers often work with a sense of urgency that does not take into consideration the ethical use of data. One paper, specifically https://www.ibm.com/watson/assets/duo/pdf/everydayethics.pdf (IBM Paper) highlights some of the ethical problems that can occur when data scientists and engineers do not begin, and perform, their work with ethics in mind.

For example, technical personnel such as data scientists and engineers may be completely unaware of corporate, local, national, or international, policies related to the data they are working with, yet there is no way to hold them accountable for this lack of knowledge. As another example, technical personnel working on analytical models may lack knowledge regarding the values and cultural norms of the users who come into contact with their work. Further, some technical personnel may avoid putting in the work to explain their model output, so that business users do not really understand the insight, as embodied in the model that has been developed, in the context of how it was generated. Moreover, technical personnel may, consciously or not, avoid looking at the data for potential bias and as a result, may create unfair, non-inclusive insights that do not represent under-represented user communities. Finally, model development processes, and the personnel developing the models, may lack consideration or awareness of the data rights of users that will be impacted by operation of the model, or who are otherwise involved with the model in some way.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses an example implementation to enable an AI Ethics datastore data structure.

FIG. 2 discloses an example workflow for a new organization participating in AI Ethics scoring of assets.

FIG. 3 discloses an example workflow for the registration of a new asset in AI Ethics datastore and utilization of the asset.

FIG. 4 discloses an example AI ethics store use case.

FIG. 5 discloses aspects of an example computing entity operable to perform any of the disclosed methods, processes, and operations.

### DETAILED DESCRIPTION OF SOME EXAMPLE EMBODIMENTS

Embodiments of the present invention generally relate processes for the generation and use of various analytical models. More particularly, at least some embodiments of the invention relate to systems, hardware, software, computer-readable media, and methods for creation and use of AI (artificial intelligence) ethics data stores that enable the ability to score the ethical efforts made by developers and other personnel during the development of analytical models.

Data scientists and other technical personnel are often given a business problem and may jump right to data-related activities such as data discovery, exploration, cleaning, transformation, and modeling. These personnel can lack insight into ethical considerations related to their work. As such, example embodiments of the invention include processes and techniques for tracking the “ethical effort” made by data scientists via the implementation of AI ethics data stores. These AI ethics data stores may enable the ability to “score” the ethical efforts made during the development of analytic models.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments of the invention is that users of analytical models may be provided some assurance that the models were developed in a way that accounted for applicable ethical principles concerning the use of, and results generated by, those models. As another example, an enterprise in the business of generating analytical models may be provided some assurance that the employees of the business are conforming with applicable ethical principles in the discharge of their work duties. In an embodiment, a business entity may be provided with a mechanism to assess, and improve, the extent to which its analytical models conform with relevant ethical principles. Various other advantages of some example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Example Challenges Relating to Example Embodiments

Following is a discussion of some examples of problems that may be resolved, or avoided, by example embodiments of the invention. This discussion is not intended, nor should be construed, to limit the scope of the invention in any way.

A particular technical problem related to the development of ethical insights is the lack of an end-to-end system or other mechanism that produces a catalog of analytical models with clear, and provable, ethical measurements. The following discussion provides some insights into the difficulties related to building such an end-to-end system.

One such difficulty concerns the lack of a glossary/mapping of/to ethical definitions. Particularly, data models that publish insights are often stored in a data catalog that lives apart from an existent or non-existent definition of the ethical considerations that should be considered during model development. In other words, most analytic models are published without any ethical context. There is no history that describes the AI ethics policies or guidelines that the engineers or scientists were aware of, or should have been aware of, when they developed their models.

Further, there is presently no known mechanism to provide proof-of-effort to comply with ethical guidelines. In particular, even if there were a well-known glossary or set of guidelines that were available for the development of ethical algorithms, there is no proof or evidence available to understand or prove that the engineer/scientist(s) were aware of those guidelines, nor is there any way to understand or capture the effort taken by those engineers or scientists to comply with the guidelines or follow the definitions.

Yet another difficulty concerns the general lack of contributor or organizational lineage. For example, a catalog of analytic models is often untethered to the engineers/scientist(s) and/or the organization(s) that created or co-authored the model. This inability to track lineage, that is, the ongoing relationship between a model and its developers, results in a variety of problems. For example, the engineer/scientist cannot be held accountable for ethical violations since there is no demonstrable link between the engineer/scientist and the model. Correspondingly, the organization that developed the model is likewise unaccountable for the model, and the results produced by the model. Finally, the organization may play a specific role within the company that exposes it to further scrutiny and/or policies, such as, for example, handling of customer data, and administration of financial records.

Another shortcoming that may be addressed, or avoided, by example embodiments of the invention concerns peer review of models and model development processes. In particular, if a data engineer/scientist were provided with some ability to document their attempts at complying with ethical guidelines, this documentation may, at best, be unsubstantiated, biased, or a perfunctory “hand-waving” gesture to try and convince a third party that ethical due diligence occurred during the development of a model by that data engineer or scientist. There is currently no system component or process that allows for peer review and feedback related to the documented ethical efforts of a data science, or other, technical team. Moreover, there is likewise no mechanism to gather information concerning, and/or to assess the reputation of, the reviewers, and the subjects of their reviews.

A related concern is the lack of objective, and automated, review of AI models and model development processes. For example, even if peer-review of ethical efforts were somehow provided for a given analytic model and/or model developer, this review may be subjective and, therefore, an inaccurate or unreliable record of the ethics of the model and its development process. At present, however, there are no Al-based tools that are able to handle information concerning ethical aspects relating to model development, and then perform an objective, automated, and machine-based review of ethical effort. Examples of such ethical aspects may include ethical definitions, efforts undertaken by a scientist or engineer during a model development process to comply with the ethical definitions, and the peer reviews and feedback of corporate experts based on their reputation.

Finally, and as illustrated by the various challenges noted in the preceding discussion, there is presently no ability to query/compare models for ethical compliance. That is, there is no method for any given model in a corporate system, to generate, access, or service requests for, the “ethics score” of that model relative to corporate ethics policies and standards. Correspondingly, there is no way to explore how such a score would be calculated, nor is there a method to find high- or low-ranking ethical models.

Due, at least, to the challenges noted in the preceding discussion, there is presently no ability for an entity, such as a business entity for example, to measure how it is performing on the AI ethics front. This lack of ability, in turn, may impair, if not prevent, a business entity to take any corrective actions.

### B. Aspects of Some Example Embodiments

As noted in the preceding discussion, there are various challenges that may be addressed by technical solutions that include example embodiments of the invention. The following discussion concerns more detailed aspects of some example embodiments.

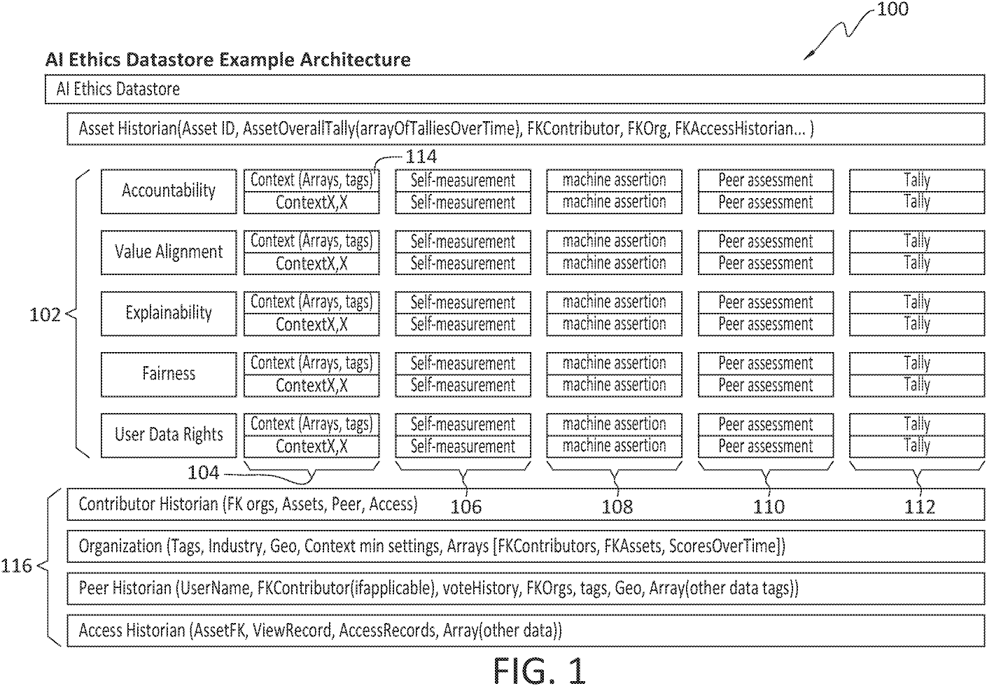

Among other things, example embodiments of the invention are directed to the creation and use of a system for generating and measuring AI (artificial intelligence) ethics. To this end, example embodiments may employ various components and services. One such component is an AI ethics datastore, which may be configured to store, and version, context, rules and data points for various defined pillars of AI ethics and associated assets, where such assets may include, for example, algorithms, AI platforms comprising hardware and/or software, hardware, and software. Example embodiments of an AI datastore may store organizational content for contributors and peer reviewers of content. As well, embodiments of an AI datastore may store AI ethics scores, tallies and historical data for ongoing traceability. An example of a service that may be employed by some example embodiments is an AI ETS (Ethics Tally Service) that may perform various operations including, but not limited to, continuous generation of asset AI ethics scores for overall assets based on self, peer, and machine, assessment (1) across all AI ethics pillars, (2) on individual pillars per asset per version per context, (3) as compared to an organizational pillar requirements, and (4) over a defined period of time. The AI ETS may be performed with respect to data and metadata stored in a data structure, an example implementation of which is discussed in connection with FIG. 1.

The AI ethics of an asset, organization, or other entity, may be scored in various ways, and the scope of the invention is not limited to the use of any particular AI ethics scoring approach. Some example embodiments may employ the five so-called ‘pillars’ of AI ethics that are recognized by industry, and documented in the IBM Paper (incorporated herein in its entirety by this reference). These pillars include: (1) accountability; (2) value alignment; (3) explainability; (4) fairness; and, (5) user data rights. Note that the scope of the invention is not limited to these pillars, and more, and different, pillars may be employed in some embodiments. In general, the efforts of an individual and/or an enterprise to address ethical considerations in their development and use of an AI model may be assessed, on various bases, with respect to each of the different pillars.

Example embodiments may thus include an extensible data structure built around a group of pillars, such as those mentioned above. An example of such a data structure is denoted generally at 100 in FIG. 1, which is directed to an example implementation of an AI ethics datastore data structure. In general, the data structure 100 may be configured to support the collection and versioning of data and metadata relating to one or more of the pillars, which are collectively denoted at 102.

### B.1 Context Measurement for Assets

Various details may then be identified and employed which may enable each of the pillars 102 to be measurable as a constituent of the overall context for an asset. That is, the context identified for a pillar may provide a measurable indicator of an extent to which, with regard to that particular pillar, the asset measures up, or does not measure up, with respect to an established standard for that pillar. As explained below, the overall measured context for an asset may be compared with a required context established by an organization or other entity. The context data 104 respectively associated with each of the pillars 102 may be represented in multiple different ways. For example, context data 104 may be expressed in terms of, or comprise, elements such as minimum action checklists, natural language requirements, workflows, and assignment of signature by completing parties.

### B.2 Asset Assessment Based on Context Data

After the overall context, which may comprise various context data 104 associated with a respective pillar, has been established for a particular asset, various methods for assessing the asset with respect to the various pillars, using the context that has been determined for each pillar, may be applied. The data, metadata, and other information gathered in connection with these measurement processes may be stored in the data structure 100. No particular measurement process, or group of measurement processes, is required to be performed for any particular embodiment.

As shown in FIG. 1, a self-assessment may be performed by a human for any one or more of the pillars 102. For example, a user, such as the creator of an asset such as an AI model, may keep a record 106 of actions taken by the user during development of the AI model. Further, the user use may self-score the completeness of her actions, for the asset, against the context of a specific pillar, or pillars.

Yet other measurement processes may be performed, with respect to one or more pillars, by a machine rather than by a human. For example, a machine implemented measurement process may independently, and automatically according to a schedule or other basis, validate the measurable context data 104 against supplied data. For example, the context data 104 for ‘user data rights’ may be evaluated against data privacy standards promulgated by an authority, or by a company, using a language processing program or algorithm. The outcome of the machine implemented measurement process may be stored as machine assertion data 108. The machine implemented measurement may use any of a variety of mechanisms to assess the context data 104 against the supplied data. Such mechanisms may include, but are not limited to, field-matching, and natural language processing (NLP).

Still other measurement processes may be performed by one or more peers of the person, or persons, who have created, or are in the process of creating, software such as an AI model. In one example, a peer assessment process may be performed which generates, for one or more of the pillars, corresponding peer assessment data 110 that captures an extent to which an asset is determined, by the peers, to comply with various established standards. In one particular example, a peer assessment process may involve the crowdsourcing of external assessments of supplied actions, that is, actions performed concerning the asset, and performance of an independent audit of asset compliance for each asset based on the context data 104 for one or more of the pillars 102. The peer assessment may be enabled, for example, by inspection of the context data 104, and/or the transparency of reported actions via self-assessment by a user associated with the asset.

With respect to the various context assessment processes referenced in FIG. 1, it is noted that because context and learning change may over time, embodiments may enable versioning and tracing of assets, development of measurable context, self-assessment, machine assessment, and peer assessment over time, as well as the generation of score tallies 112 for the various data relating to a pillar 102. In some embodiments, development or modification of an asset may be temporarily, or permanently, halted based on the outcome of one or more context assessment processes. As part of a halt, a user may be informed as to the reason for the stop, and advised as to the corrective action(s) that need to be taken to re-start the model development process. This approach may be relatively efficient as some problems may be resolved on the fly during asset development, rather than waiting to identify and resolve those problems after the fact when the model has been completed.

With continued reference to the example data structure 100, it was noted earlier herein that embodiments of the data structure 100 may support storage of versioned, asset-specific, independent context, by pillar, and crossing all assessment mechanisms. The data structure 100 may also store ongoing tallying of scores 112 at the pillar level, and at an overall asset level whose score may be obtained by adding all the scores 112 together. This approach may enable an any point-in-time representation of a score 112 at the pillar level and/or an overall asset-level score.

While the data generated and evaluated by example embodiments is valuable, it may be a non-trivial exercise to store all of that data in the data structure 100, at least because the data may not scale to an extent that enables it to be efficiently stored and accessed. As such, example embodiments may employ the use of metadata tags, such as the example metadata tags 114, and rules associated with organizations and contributors, as well as peer and access historians 116 to enable a usable, repeatable process for accessing and utilizing the score data in decision making. For example, a user may request context data 104 by specifying an array where that context data 104 is stored, and one or more tags that specifically identify the requested context data 104.

### B.3 Generation of Context Data

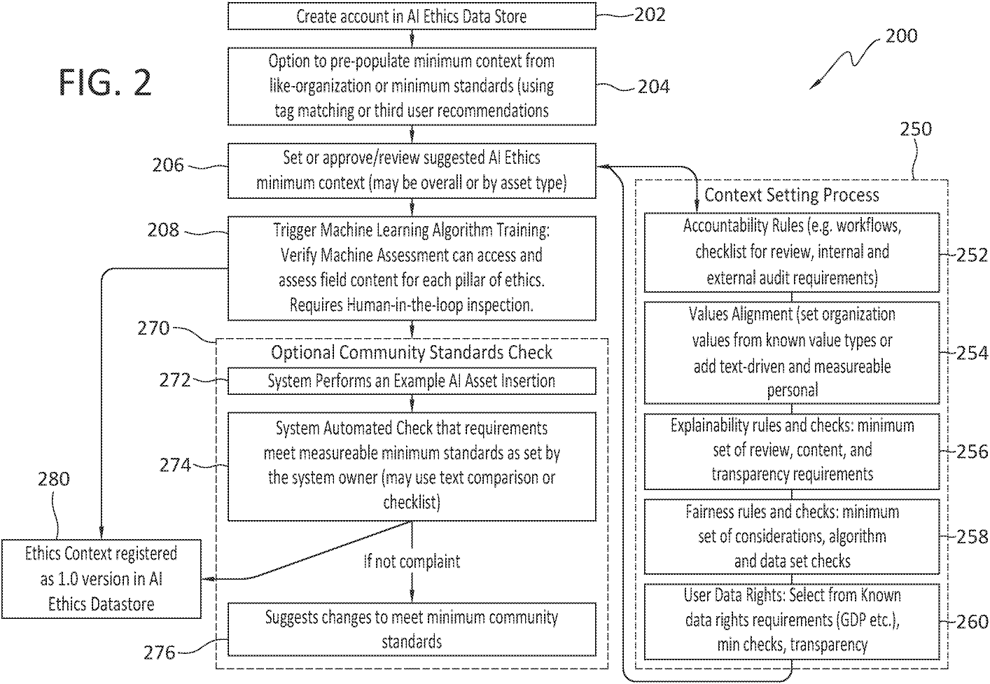

With attention next to FIG. 2, further details are provided concerning processes for the generation of context data for one or more pillars, such as the context data 104 referred to in FIG. 1 for example. In general, example embodiments may enable an organization, such as a group of contributors, to create minimum context requirements for a pillar, or pillars. Additional context requirements and context data may be added to the minimum context requirements, but the minimum context requirements may be those necessary to enable a meaningful assessment of the performance of an asset and/or company with respect to a particular pillar, or pillars. Thus, FIG. 2 discloses an example workflow, denoted as method 200, that may be employed by a new organization that wishes to participate in AI ethics scoring of assets.

The method 200 may be performed by one or more entities of the organization, and the entities may comprise humans, and/or computing entities that comprise hardware and/or software. The method 200 may begin when the organization creates 202 an account in an AI ethics datastore, an example of which is denoted at 100 in FIG. 1. Next, data that may already be present in the AI ethics datastore for other organizations, or subgroups or departments within a single organization, may be used to prepopulate 204 some minimum amount of context for each pillar, based on an existing set of rules of the organization, or based on rules that have been contributed by other similar companies, organizations, or other third parties. This pre-populated minimum context dataset may then be reviewed 206 and altered, possibly on a pillar-by-pillar basis and, upon approval, set as the minimum context data for all assets contributed by members of the organization.

In some embodiments, these rules may be published for utilization by other organizations, or departments within an organization. Publication of the rules in this way may help to take advantage of lessons learned, and may also enable other organizations and departments to bring their AI ethics scoring processes online.

With continued reference to FIG. 2, the review 206 process may access or invoke a context setting process 250. As shown, the context setting process 250 may make various types of content available that may be used to set the minimum context data for an asset. Such content may include, but is not limited to, accountability rules 252, values alignment data and information 254, explainability rules and checks 256, fairness rules and checks 258, and user data rights 260.

In more detail, accountability rules 252 may provide a mechanism to hold a user accountable for their lack of knowledge or awareness of, for example, corporate, local, national, or international, policies related to the data or model that the user is working with. Further, values alignment data and information 254 be made available to an engineer or scientist who is working on analytical models but lacks knowledge regarding the values and cultural norms of the users who come into contact with their work. As well, explainability rules and checks 256 may require technical personnel to invest the time and effort to explain their model output, so as to enable business users to understand the insight, as embodied in the model that has been developed, and in the context of how the model was generated. Further, fairness rules and checks 258 may be used to guide, and assess, the behavior of technical personnel may, consciously or not, avoid looking at the data for potential bias and as a result, may create unfair, non-inclusive insights that do not represent under-represented user communities. Finally, rules concerning user data rights 260 may provide a mechanism to provide technical personnel with consideration and awareness of the data rights of users that will be impacted by operation of the model, or who are otherwise involved with the model in some way.

With respect to these example rules, an organization may choose to set the rules by asset type. For example, assets dealing with private data may have a different set of minimum context than assets which do not deal with private data. As such, the data rights rules 260 may not be included in the minimum context data for assets that do not implicate private data.

After completion of the context setting process 250, the method 200 may proceed to 208 where an ML/AI algorithm training process may be triggered. In general, the training process may serve to configure an AI/ML model to perform machine-based context data assessments, examples of which are discussed in connection with FIG. 1. Upon successful completion of the training process 208, which may be overseen and controlled by a human, a minimum ethics context may be registered 280 as an initial 1.0 version in an AI ethics datastore.

With continued reference now to FIG. 2, the example method 200 may also provide for a community standards check 270. The community standards check 270 may implement a comparison of an asset against community standards by performing an example AI asset insertion 272, and then performing an automated check 274 of the asset against various specified minimum standards. If the asset does not meet the specified minimum standards, suggestions may be generated 276 explaining what changes should be implemented to ensure compliance with the community standards. On the other hand, if the asset meets the specified minimum standards, a minimum ethics context for the asset may be registered 280 as an initial 1.0 version in an AI ethics datastore.

### B.4 Asset Registration and Use

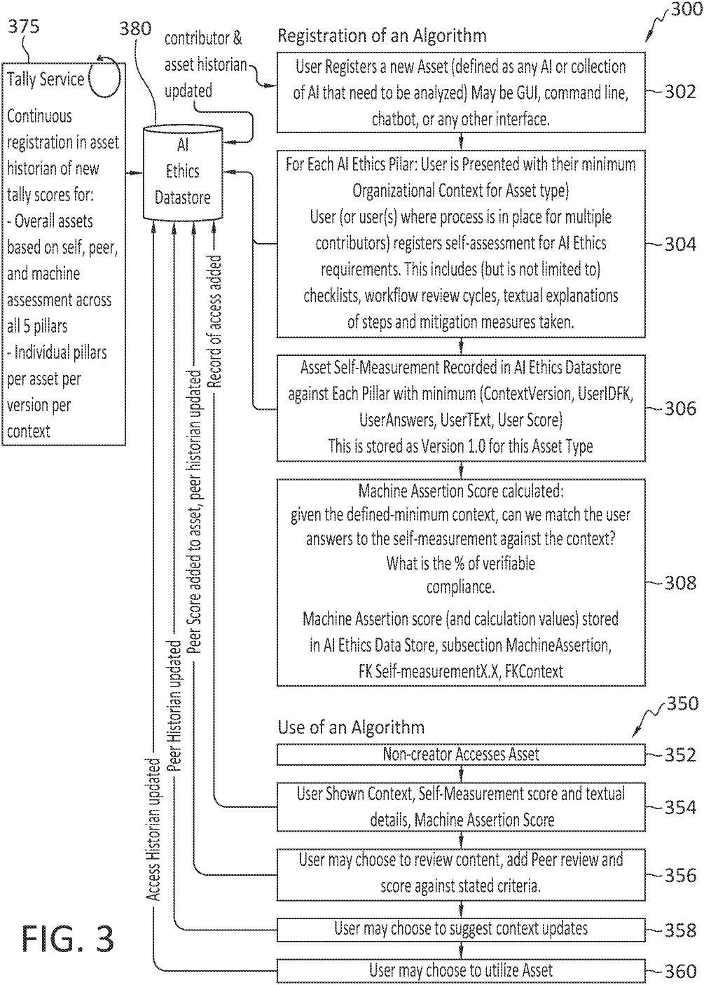

Once a company is satisfied with minimum context, such as after having performed the processes disclosed in FIG. 2, for example, the context rules identified as a result of those processes may be stored as minimum requirements which may be prepopulated when a user of the organization registers an asset, such as an algorithm or an AI/ML model. FIG. 3 discloses an example workflow, namely, method 300, for the registration of a new asset in an AI ethics datastore, and a method 350 for the utilization of the asset. In general, and as shown in FIG. 3, the methods 300 and/or 350 may be performed in connection with a tally service 375 that communicates with an AI ethics datastore 380. At any stage of the methods 300 and 350, corresponding updates may be made to the AI ethics datastore 380.

The method 300 may begin when a user registers 302 a new asset. Next, for each AI ethics pillar, the user may be presented with the minimum context defined by the organization for the asset that the user has registered 302, and the user may register 304 an asset self-assessment that has been performed with respect to those pillars for the asset. The asset self-assessment may then be recorded 304 in the AI ethics datastore 308 in association with the respective context data for each pillar. Because the method 300 may comprise an initial registration process for an asset, the self-assessment may be recorded 304 as a Version 1.0 for the asset. After the asset self-assessment has been recorded 304, a machine assertion score may be generated with respect to the newly registered asset, and recorded 308 in the AI ethics datastore 380. Thus, at the conclusion of the example method 300, the asset may be recorded with minimum contextual data for each of a group of pillars, where the minimum contextual data includes self-assessment and machine assertion scores and data generated and stored in association with the asset and the pillars.

At some point after the asset, such as an algorithm for example, has been registered, a user other than the person or entity who created the asset may wish to use it. Thus, the method 350 may begin when that user accesses 352 the registered asset. The user may then be able to access 354 various information, data including context data, and metadata, concerning the registered asset. In conjunction with the access 354, the AI ethics datastore 380 may be updated to record that the asset was accessed.

The user may then choose to review 356 the context data, and may add, to the AI ethics datastore 380, additional context data and other information and metadata, and associate these additional materials with the asset. For example, the user may add peer review data and an associated score, and the peer historian of the AI ethics datastore 380 updated accordingly. The user may additionally choose 358 to suggest context updates, which may then be stored in the AI ethics datastore 380, and the contributor historian updated accordingly. Finally, the user may choose to utilize 360 the asset that has been accessed, and the access historian may be updated to reflect that access.

With continued reference to the example of FIG. 3, a new asset registration process 300 may insert asset records in the AI Ethics datastore 380 with prepopulated minimum context for each supported pillar. The registering user may be required to complete and supply testimony and attestation of activities completed to meet the context. Examples of this may include attestation of attended names and approvals for review meetings, link to code for external access/ review, documentation of use of data, and security certifications. The user may then assign itself a score of how well they assess themselves against the pillar and context. This score may be stored in the AI ethics datastore 308.

The tally service 375 may run an algorithm to compare the user-supplied data against the known context requirements and may also supply a validation of context content, keywords, and scores the self-assessment against the context. This validation may be stored in the machine-assessment section of a the AI ethics datastore 380, and the tally service may then calculate a respective % match tally/score for one or more of the pillars that apply to the newly registered asset. The tally service 375 algorithm may be updated over time, which may result in the kicking off of a new tally version, that may be stored in the AI ethics datastore 380 as additive data.

As both self-assessment and machine-assessment of context supplied may be susceptible to errors, embodiments of the invention may provide a peer feedback loop. Particularly, embodiments may implement the collection and collation of peer feedback. Users of the algorithm, independent reviewers, or other peers may access the algorithm, assessment datapoints, and context, and return their own assessment against the known context of the asset. This peer assessment may be stored in the datastore at the context/pillar/version level. Feedback on missing or outdated context definitions may also collected and this feedback may be stored in the peer historian. This feedback may be utilized by contributors and organizations to make informed future context definitions.

### B.5 Generating Scores

Scores of AI ethics for an asset may be accomplished in various ways. Following is a discussion of one example approach for scoring. It is noted that the scope of the invention is not limited to this example, which is provided for the purposes of illustration, and not limitation. Various other scoring mechanisms may be employed in other embodiments.

An illustrative AI ethics scoring algorithm may be configured as follows:
Is the algorithm, that is, asset, registered with the AI Ethics Datastore +1
For each pillar:
   o Does context match the required organizational context +1
   o What is the self-measurement score (as a % of required context) +0-10
   o What is the machine assessment score (as a % of required context) +0-10
   o Are there peer scores? If yes, as a % of required context +0-10
In this example, there is a total possible score of 156. Weighted algorithms which emphasize a specific pillar, score mechanism, or other aspect may be employed as well by the host of the AI ethics datastore. Some embodiments may provide for the creation of more than one tally, and the storing of more than one score, in association with the context of the rule/algorithm which created that score.

### C. Further Discussion

As will be apparent from this disclosure, example embodiments may provide various features and advantages. For example, some embodiments may provide a system that is context-aware in establishing AI ethics guidelines and definitions, as applied generally and against specific assets, enabling measurement across multiple pillars of ethics, and measuring and generating scores of AI Ethics using the data stored. As another example, and in view of the aforementioned features, embodiments may comprise a mechanism for proof of effort in complying with AI ethics guidelines. As well, embodiments may provide for generation of organizational and contributor historical lineage of AI ethics compliance and scores of compliance over time. Example embodiments may enable peer assessment of assets in comparison to known context for asset compliance to AI ethics standards. As a final example, embodiments may provide the ability to run comparative queries against assets and models for understanding AI ethics compliance against established contexts.

### D. Example Use Case

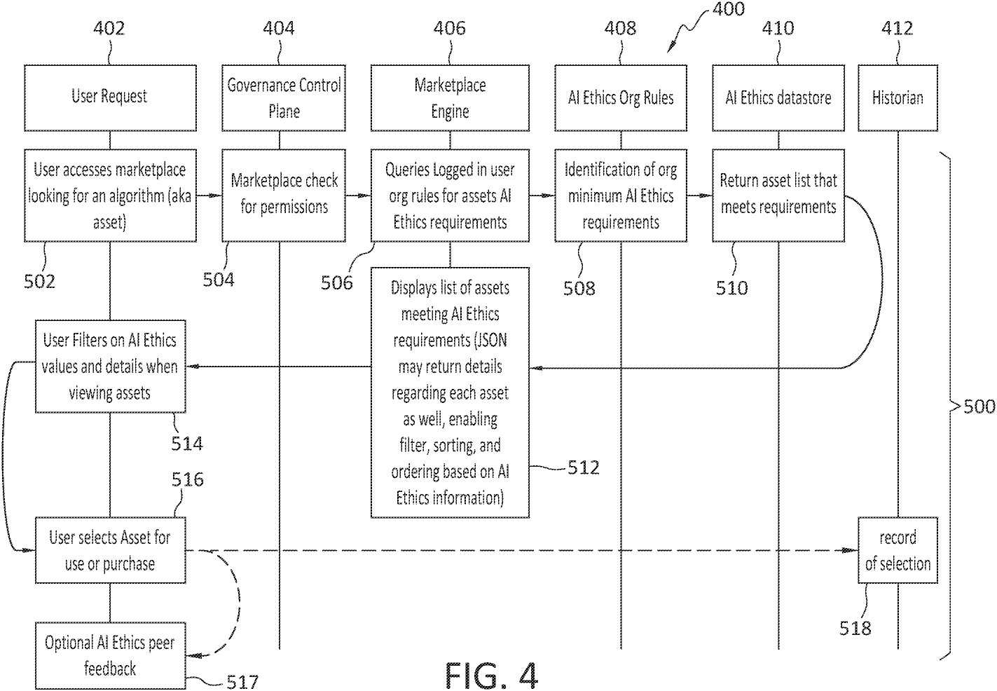

With reference now to FIG. 4, aspects of an example use case for some embodiments of the invention are disclosed. Particularly, FIG. 4 discloses an example of how the AI ethics datastore may be used to establish an improvement in asset marketplaces. The basic elements in this example use case 400 include, but are not limited to, a user request 402, governance control plane (GCP) 404, marketplace engine 406, AI ethics organization rules 408, an AI ethics datastore 410, and a historian 412.

In this example, the use case 400 takes the form a use case and method 500 which may begin when a user accesses 502 a marketplace to use or purchase an asset, such as an algorithm, hardware, or software, for example. At the GCP 404, a check 504 may be performed to verify that the user has the permissions necessary to access the asset. Next, the marketplace engine 406 may then query 506 the rules of the organization of the logged-in user to determine the ethics requirements of that organization that may pertain to the requested asset. As a result of the query 506 of the AI ethics organization rules 408, an identification 508 may be made of the minimum AI ethics requirements of that organization.

Once the ethical context of the user, and the organization to which the user belongs, has been determined, the AI ethics datastore 410 may query all of the ethical metadata for each algorithm to identify one or more matching assets, and may then return 510, to the marketplace engine 406, a list of assets that meet the AI ethics requirements of the organization. Note that this approach may operate to prevent the user from accessing or using an asset that does not conform with the AI ethics requirements of the organization to which the user belongs. The list of assets may then be displayed 512 to the user by the marketplace engine 406, and the user may filter 514 the displayed items. After the filtering 514, if performed, the user may then select 516 one of the displayed items for use or purchase, and the selection 516 may be recorded 518 at the historian. Finally, the user may provide AI ethics peer feedback 517 concerning the asset, and this peer feedback may be recorded 518 at the historian.

Thus, the example approach disclosed in FIG. 4 may enable a user to choose assets whose context matches the context of the logged in organization, that is, there is an alignment of values between the user, organization, and asset. Further, this approach may enable a user to choose assets whose explainability is comprehensible in the language of the logged in user. For example, a Spanish-speaking user can use assets whose explainability context is Spanish-language supported. Finally, this approach may enable a user to order assets by cumulative score of the contributor AI ethics which, in turn, may help the user to make a decision about accessing an asset based on historical evidence that the organization and asset support AI ethics.

### E. Example Methods

It is noted with respect to the example methods disclosed herein that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

### F. Further Example Embodiments

Following are some further example embodiments of the invention. These are presented only by way of example and are not intended to limit the scope of the invention in any way.

Embodiment 1. for each pillar in a group of AI ethics pillars, storing, in a datastore, context data concerning the AI ethics pillar, and the context data is determined using context rules; storing, in the datastore, the context rules as minimum context requirements; receiving, by the datastore, a request from a user to register an asset in the datastore; when user-supplied context information for the asset meets ethical requirements specified by the context rules, registering the asset in the datastore; and ensuring that an assessment mechanism is able to access, and assess, the context data for each AI ethics pillar.

Embodiment 2. The method as recited in embodiment 1, wherein the AI ethics pillars comprise, at a minimum, accountability, value alignment, explainability, fairness, and user data rights.

Embodiment 3. The method as recited in any of embodiments 1-2, wherein the assessment mechanism is a machine-based assessment mechanism.

Embodiment 4. The method as recited in any of embodiments 1-3, wherein the asset is an algorithm.

Embodiment 5. The method as recited in any of embodiments 1-4, further comprising receiving, and storing in the datastore, in association with the asset, results of an assessment process performed concerning the asset with respect to the AI ethics pillars.

Embodiment 6. The method as recited in embodiment 5, wherein the assessment process comprises any one or more of: a self-measurement process performed by the user; an assessment process performed by a machine learning algorithm; and, a peer assessment process.

Embodiment 7. The method as recited in embodiment 6, further comprising generating, for one or more of the AI ethics pillars, a respective tally score based on the context data for the AI ethics pillar and based on results of the assessment processes.

Embodiment 8. The method as recited in any of embodiments 1-7, further comprising versioning and tracing, over time, the asset, context data, and results of assessments of the asset.

Embodiment 9. The method as recited in any of embodiments 1-8, further comprising: receiving, from a requestor, a request to use the asset; and when the context data of the asset complies with context data of an organization to which the requestor belongs, making the asset available to the requestor.

Embodiment 10. The method as recited in any of embodiments 1-9, further comprising generating a historical lineage of AI ethics compliance for the asset.

Embodiment 11. A method and system for performing any of the operations, methods, and processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

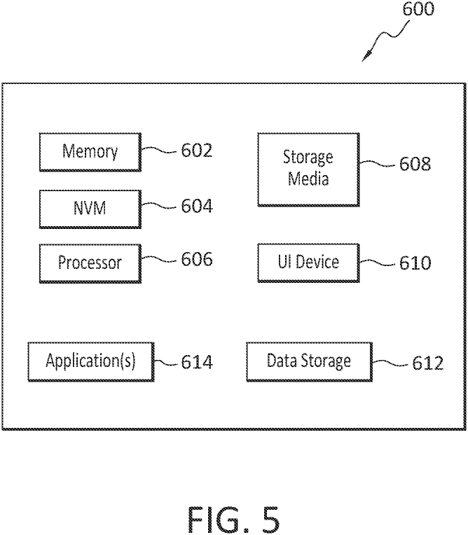

With reference briefly now to FIG. 5, any one or more of the entities disclosed, or implied, by FIGS. 1-4 and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 5.

In the example of FIG. 5, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
for each AI ethics pillar in a group of AI ethics pillars, storing, in a datastore, context data concerning that AI ethics pillar, and the context data is determined using context rules;
storing, in the datastore, the context rules as minimum context requirements;
receiving, by the datastore, a request from a user to register an asset in the datastore;
when user-supplied context information for the asset meets ethical requirements specified by the context rules, registering the asset in the datastore; and
ensuring that an assessment mechanism is able to access, and assess, the context data for each AI ethics pillar.

2. The method as recited in claim 1, wherein the AI ethics pillars comprise accountability, value alignment, explainability, fairness, and user data rights.

3. The method as recited in claim 1, wherein the assessment mechanism is a machine-based assessment mechanism.

4. The method as recited in claim 1, wherein the asset is an algorithm.

5. The method as recited in claim 1, further comprising receiving, and storing in the datastore, in association with the asset, results of an assessment process performed concerning the asset with respect to the AI ethics pillars.

6. The method as recited in claim 5, wherein the assessment process comprises any one or more of: a self-measurement process performed by the user; an assessment process performed by a machine learning algorithm; and, a peer assessment process.

7. The method as recited in claim 6, further comprising generating, for one or more of the AI ethics pillars, a respective tally score based on the context data for the AI ethics pillar and based on results of the assessment processes.

8. The method as recited in claim 1, further comprising versioning and tracing, over time, the asset, context data, and results of assessments of the asset.

9. The method as recited in claim 1, further comprising:
receiving, from a requestor, a request to use the asset; and
when the context data of the asset complies with context data of an organization to which the requestor belongs, making the asset available to the requestor.

10. The method as recited in claim 1, further comprising generating a historical lineage of AI ethics compliance for the asset.

11. A non-transitory storage medium having stored therein instructions that are executable by one or more hardware processors to perform operations comprising:
for each AI ethics pillar in a group of AI ethics pillars, storing, in a datastore, context data concerning that AI ethics pillar, and the context data is determined using context rules;
storing, in the datastore, the context rules as minimum context requirements;
receiving, by the datastore, a request from a user to register an asset in the datastore;
when user-supplied context information for the asset meets ethical requirements specified by the context rules, registering the asset in the datastore; and
ensuring that an assessment mechanism is able to access, and assess, the context data for each AI ethics pillar.

12. The non-transitory storage medium as recited in claim 11, wherein the AI ethics pillars comprise accountability, value alignment, explainability, fairness, and user data rights.

13. The non-transitory storage medium as recited in claim 11, wherein the assessment mechanism is a machine-based assessment mechanism.

14. The non-transitory storage medium as recited in claim 11, wherein the asset is an algorithm.

15. The non-transitory storage medium as recited in claim 11, wherein the operations further comprise receiving, and storing in the datastore, in association with the asset, results of an assessment process performed concerning the asset with respect to the AI ethics pillars.

16. The non-transitory storage medium as recited in claim 15, wherein the assessment process comprises any one or more of: a self-measurement process performed by the user; an assessment process performed by a machine learning algorithm; and, a peer assessment process.

17. The non-transitory storage medium as recited in claim 16, wherein the operations further comprise generating, for one or more of the AI ethics pillars, a respective tally score based on the context data for the AI ethics pillar and based on results of the assessment processes.

18. The non-transitory storage medium as recited in claim 11, wherein the operations further comprise versioning and tracing, over time, the asset, context data, and results of assessments of the asset.

19. The non-transitory storage medium as recited in claim 11, wherein the operations further comprise:
receiving, from a requestor, a request to use the asset; and
when the context data of the asset complies with context data of an organization to which the requestor belongs, making the asset available to the requestor.

20. The non-transitory storage medium as recited in claim 11, wherein the operations further comprise generating a historical lineage of AI ethics compliance for the asset.
